(19) United States
(12) Patent Application Publication
(10) Pub. No.: US 2013/0337421 A1
(43) Pub. Date: Dec. 19, 2013

(54) Recognition and Feedback of Facial and Vocal Emotions

(71) Applicant: INTERNATIONAL BUSINESS MACHINES CORPORATION, Armonk, NY (US)

(72) Inventor: John Kenyon Gerken, III, Apex, NC (US)

(73) Assignee: INTERNATIONAL BUSINESS MACHINES CORPORATION, Armonk, NY (US)

(21) Appl. No.: 13/741,111

(22) Filed: Jan. 14, 2013

Related U.S. Application Data
(63) Continuation of application No. 13/526,713, filed on Jun. 19, 2012.

(51) Int. Cl. G09B 5/00

(52) U.S. Cl. CPC G09B 5/00
USPC 434/236

(57) ABSTRACT

An approach is provided for an information handling system that identifies emotions and notifies a user that may otherwise have difficulty identifying the emotions displayed by others. A set of real-time inputs, such as audio and video inputs, are received at one or more receivers. The inputs are received from a human subject who is interacting with a user of the information handling system with the information handling system being a portable system carried by the user. The received set of real-time inputs are compared to predefined sets of emotional characteristics in order to identify an emotion that is being displayed by the human subject. Feedback is provided to the user of the system regarding the identified emotion exhibited by the human subject.

### TECHNICAL FIELD

The present disclosure relates to an approach that recognizes subject emotions through facial and vocal cues. More particularly, the present disclosure relates to an approach that provides such emotional identifications to a user of a portable recognition system.

### BACKGROUND OF THE INVENTION

People who have Non-visual Learning Disorder (NLD), right hemisphere brain trauma, some aspects of Asperger's, High Functioning Autism, and other neurological ailments often experience difficulty in achieving what is called “Theory of Mind.” Theory of Mind is essentially the ability of an individual to place himself or herself in the role of another person with whom the individual is communicating. People who cannot achieve Theory of Mind often score very low on visual acuity tests and have difficulty interacting socially with others. Research has shown that about two thirds of all communication between individuals is non-verbal communication such as body language, facial expressions, and paralinguistic cues. These non-verbal forms of communication are often misinterpreted or go unrecognized by those who cannot achieve Theory of Mind. Subtle cues in the environment such as: when something has gone far enough, an ability to “read between the lines,” and the idea of personal “space” are often completely missed by these individuals. This makes social situations, such as the classroom, team sports, clubs, etc., more difficult for these individuals to navigate and fully participate. Indeed, while these individuals are often very intelligent, they are also often described as having eyes that “look inward” rather than outward. Many of these individuals find that they have few, if any, friends and are often labeled as “problematic.” Because they are often intelligent, these individuals are sometimes also labeled as “underachievers” in classroom and work environments. Consequently, these individuals often have significant deficits in social judgment and social interactions that permeate most areas of their lives. While they may be good problem solvers, they often make poor decisions because they don't recognize the social impact of the things they do or say. They handle aggressive individuals poorly, often have low self esteem, and are more prone to depression and anxiety issues. Similar to most known neurological disorders, the root neurological causes of NLD, Asperger's, etc., are inoperable. While medication can help, most often these medications are treating a symptom, such as anxiety, or increasing brain hormones, such as dopamine, instead of addressing the root problem. Most non-pharmaceutical modifications and therapies helpful to these individuals are time and labor intensive. In addition, these therapies often require a high level of commitment and training by all parts of the individual's support system to be effective. While parents may be able to provide the proper environment at home, others, such as coaches, mentors, teachers, and employers, may not be willing or able to accommodate the individual's special needs such that prescribed therapies are effective.

### SUMMARY

An approach is provided for an information handling system that identifies emotions and notifies a user that may otherwise have difficulty identifying the emotions displayed by others. A set of real-time inputs, such as audio and video inputs, are received at one or more receivers. The inputs are received from a human subject who is interacting with a user of the information handling system with the information handling system being a portable system carried by the user. The received set of real-time inputs are compared to predefined sets of emotional characteristics in order to identify an emotion that is being displayed by the human subject. Feedback is provided to the user of the system regarding the identified emotion exhibited by the human subject. In one embodiment, the intensity of the emotion being displayed by the human subject is also conveyed to the user as feedback from the system. Various forms of feedback can be used, such as temperature-based feedback, vibrational feedback, audio feedback, and visual feedback, such as color and color brightness.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing interactions between components of a mobile emotion identification system in receiving and processing external emotional signals;

FIG. 4 is a flowchart showing steps performed by the mobile emotion identification system in monitoring the environment for emotional characteristics displayed by people in the environment;

FIG. 5 is a flowchart showing steps performed by a process that provides feedback to a user of the mobile emotion identification system;

FIG. 6 is a flowchart showing steps performed during subsequent analysis of the data gathered by the mobile emotion identification system; and

FIG. 7 is a flowchart showing steps performed during the subsequent analysis that focus on a trend analysis for the user of the mobile emotion identification system.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

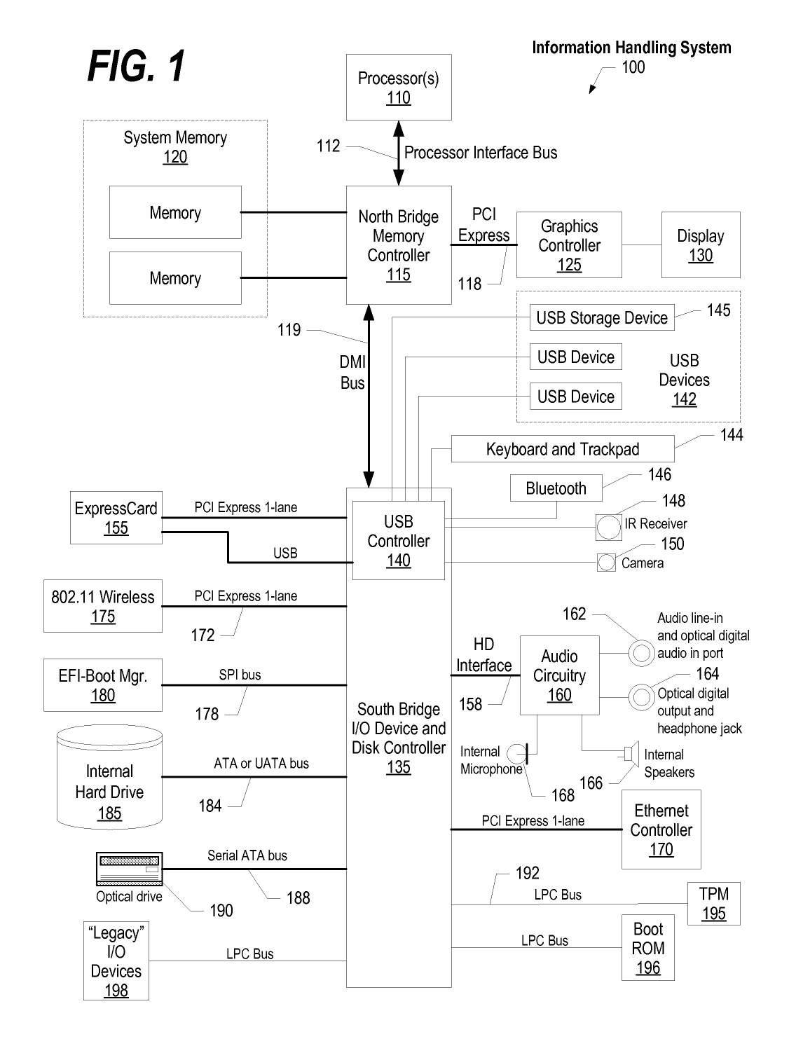

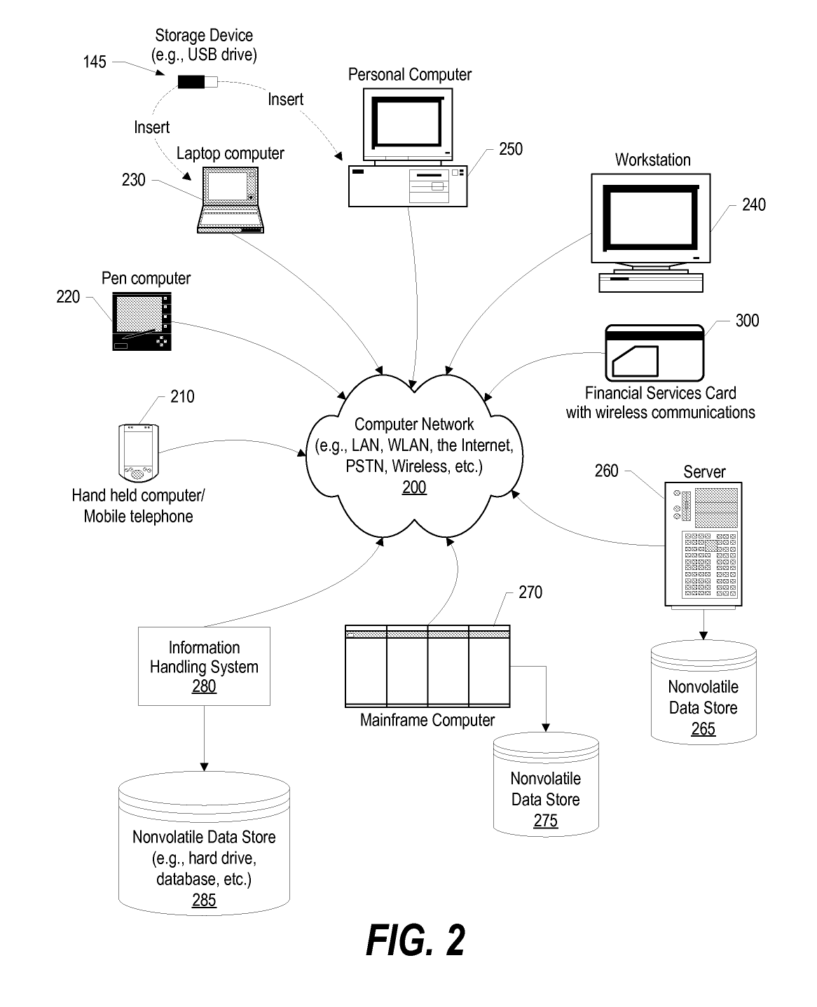

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

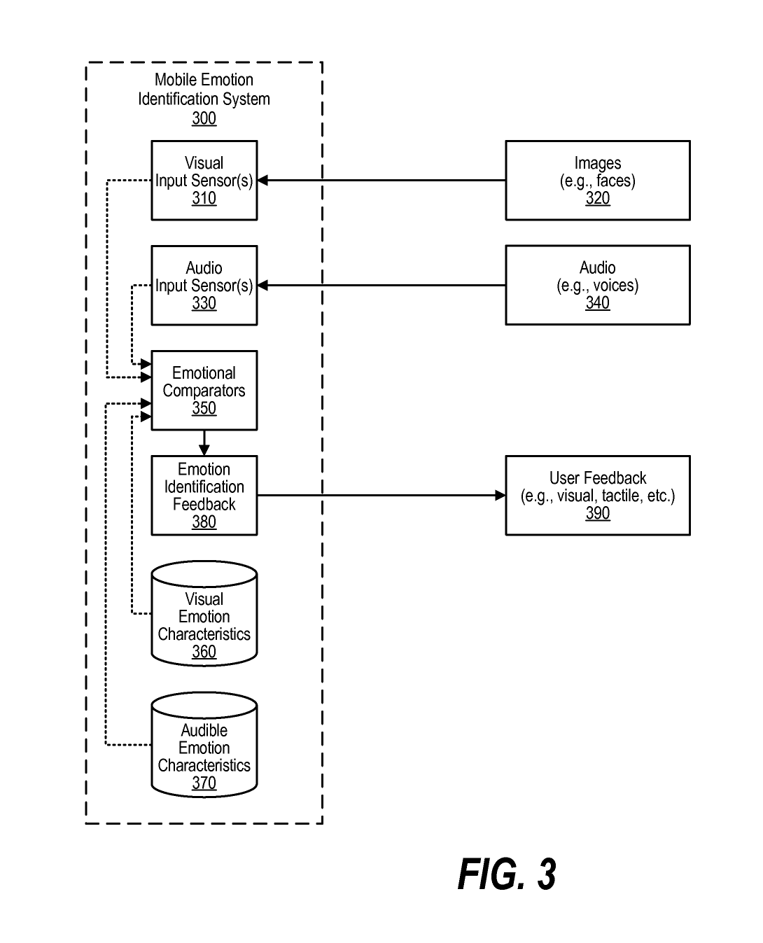

FIGS. 3-7 depict an approach that can be executed on an information handling system and computer network as shown in FIGS. 1-2. In this approach, a mobile emotion identification system is used by a user, such as someone who cannot achieve Theory of Mind or someone that may have difficulty in identifying emotions displayed by others. People with Non-visual Learning Disorder, some aspects of Asperger's Spectrum Disorder and other individuals who have difficulty in social situations often display limited ability to read emotions in the faces and voices of those around them and cannot achieve Theory of Mind. In addition, these individuals often fail to recognize how their words and actions affect others and how these words and actions impacts other people's perception of the individual. To assist these individuals, a feedback loop mechanism is provided that indicates to the user the emotions observed in the face and voice of subject humans (individuals with whom the user is interacting). The feedback loop provides real-time sensory information, which can positively influence behavior in individuals with social interaction disorders. In an example embodiment, the user carries a mobile emotion identification system which includes input receivers such as a small Bluetooth video camera with a microphone. The mobile emotion identification system may be a portable information handling system such as a smart phone. A feedback mechanism, such as a thermal (hot/cold) output device, a vibrating device (e.g., placed on the user's arm, etc.), a speaker device, such as an ear bud placed in one or both of the user's ears to produce sounds of varying pitch and intensity, and a display device, such as a multi-colored LED hidden on the inside of a glasses frame, etc. worn by the user. In addition, the mobile emotion identification system includes a storage device for storing data pertaining to the interactions that the user experiences with various subjects. A therapist or health care provider can utilize this data during treatment to help teach the user how to better understand emotions exhibited by other people.

FIG. 3 is a component diagram showing interactions between components of a mobile emotion identification system in receiving and processing external emotional signals. Mobile emotion identification system 300 includes receivers to receive a set of real-time inputs from a human subject, such as someone with whom the user is conversing or interacting. These receivers include visual input sensors 310, such as a camera included in the mobile emotion identification system, that captures images 320, such as faces and facial expressions exhibited by the human subject. The images may include still-images, video (moving) images, or a combination thereof. In addition, images 320 may include non-facial cues, such as body posture and stance, used by the human subject to convey other non-verbal cues.

Input receivers also include audio sensors 330, such as a microphone included in the mobile emotion identification system, that capture and record audio 340 from the human subject. The audio captured includes words spoken by the human subject as well as the vocal inflections used by the human subject to convey the words.

Emotion comparators 350 is a process executed by a processor included in the mobile emotion identification system that compares the set of real-time inputs received at the mobile emotion identification system with one or more sets of predefined emotional characteristics in order to identify an emotion being displayed by the human subject as well as an intensity level of the emotion displayed. The predetermined emotional characteristics are retrieved by emotion comparator process 350 from visual emotion characteristics data store 360 and audible emotion characteristics data store 370. Visual emotion characteristics data store 360 include libraries of non-verbal facial cues and libraries of body language cues. The libraries of visual cues are compared with the visual data captured by visual input sensors 310 in order to identify an emotion being visually displayed by the human subject. Audible emotion characteristics data store 370 include libraries of vocal tones and inflections. The libraries of audible cues are compared with the audio data captured by audio input sensors 330 in order to identify an emotion being audibly projected by the human subject through the vocal tones and inflections exhibited by the subject.

The emotion being displayed by the human subject is identified by emotion comparator process 350. The identified emotion is then provided to emotion identification feedback process 380 which provides feedback to the user regarding the human subject's emotion and intensity. Feedback process 380 can use a number of different feedback techniques to convey the emotion and intensity level back to the user. The feedback resulting from process 380 is provided to the user as user feedback 390. As discussed below, some of these feedback techniques are designed to be unobtrusive and not readily detected by the human subject in order to provide a more natural interaction between the user and the human subject.

One feedback technique is to use a thermal output that provides temperature-based feedback that is felt by the user. For example, a cooler temperature can be used to inform the user that the human subject is exhibiting a positive emotion, such as happiness, joy, etc. with the degree or amount of coolness conveying the intensity of such positive emotion. Likewise, a warmer temperature can be used to inform the user that the human subject is exhibiting a negative emotion, such as anger, fear, or disappointment. Again, the degree or amount of warmth can be used to convey the intensity of such negative emotion. If desired, the temperatures can be reversed so that cooler temperatures convey the negative emotions with the warmer colors conveying the positive emotions.

Another feedback technique uses a vibrating output that touches the user to provide different tactile sensations to the user based on the identified emotion. For example, a light vibration can be used to indicate a positive emotion being displayed by the human subject, with a heavy vibration used to indicate a negative emotion. The intensity can be indicated based on increasing the frequency of the vibration. In this manner, a strong positive emotion would be conveyed using a faster light vibration. Likewise, a strong negative emotion would be conveyed using a faster heavy vibration. If desired, the vibration techniques can be reversed so that a light vibration conveys the negative emotions with the heavy vibration conveying the positive emotions.

A third feedback technique uses an audible tone directed at the user. In one embodiment, the audible tone, or signal, is played to the user in a manner that prevents it from being heard by the human subject, such as by using an ear bud or small speaker close in proximity to the user's ear. For example, a higher pitched tone can be used to indicate a positive emotion being displayed by the human subject, with a lower pitched tone used to indicate a negative emotion. The intensity can be indicated based on increasing the volume or pitch in the direction of the indicated emotion. In this manner, a strong positive emotion would be conveyed using an even higher pitch or by playing the high pitch tone at an increased volume. Likewise, a strong negative emotion would be conveyed using an even lower pitch or by playing the low pitch tone at an increased volume. If desired, the sound techniques can be reversed so that a higher pitched tone conveys the negative emotions with the lower pitched tone conveying the positive emotions.

Another feedback technique uses a visible signal, or cue, directed to the user. In one embodiment, the visible cue displayed to the user in a manner that prevents it from being seen by the human subject, such as by displaying the visible signal on one or more LED lights embedded on the inside portion of a pair of eyeglasses worn by the user. When the LED lights are illuminated, the user can see the LED lights on the inside frame using his peripheral vision, while other people, including the human subject with whom the user is interacting, cannot view the lights. For example, a green or white LED can be used as a positive visible cue to indicate a positive emotion being displayed by the human subject, with a red or blue LED used as a negative visible cue to indicate a negative emotion. The intensity can be indicated based on a blink-frequency of the LED. In this manner, a strong positive emotion would be conveyed by blinking the green or white LED more rapidly. Likewise, a strong negative emotion would be conveyed by blinking the red or blue LED more rapidly. In addition, the intensity can be conveyed using other visual cues, such as increasing the brightness of the LED to indicate a more intense emotion being displayed by the subject. Moreover, colors could be used and assigned to different emotions (e.g., laughter, contempt, embarrassment, guilt, relief, shame, etc.). Additionally, the intensity of the indicated emotion could be shown by increasing the brightness of the displayed LED. If desired, the visible cue techniques can be adjusted according to the color that the user associates with positive and negative emotions.

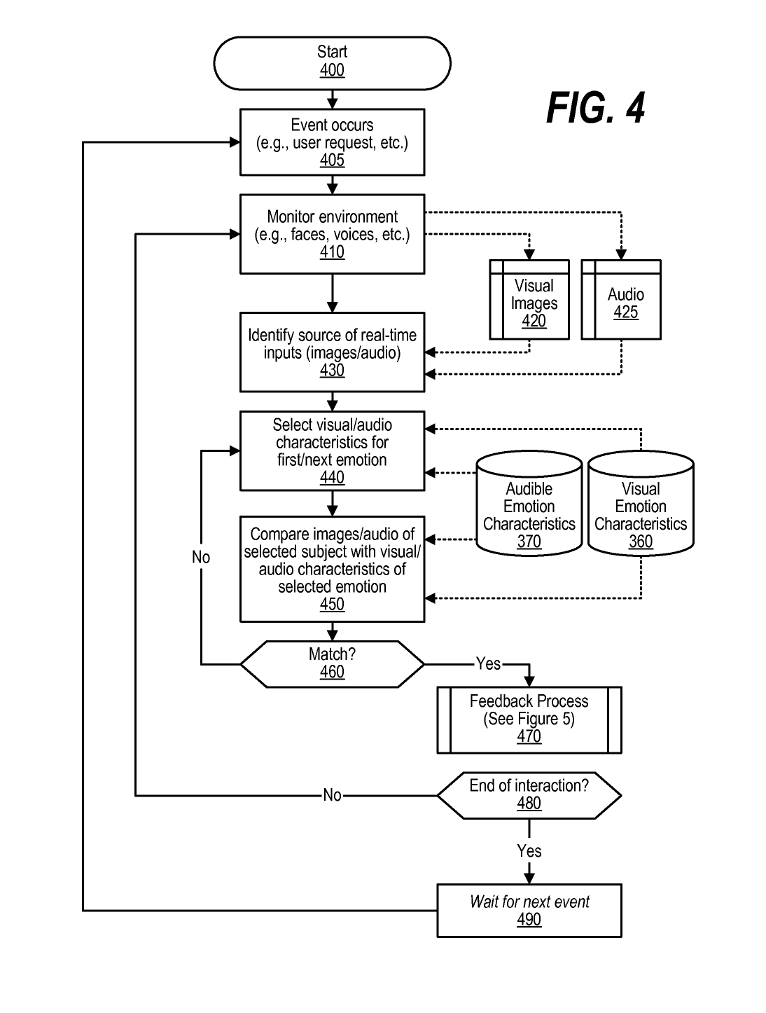

FIG. 4 is a flowchart showing steps performed by the mobile emotion identification system in monitoring the environment for emotional characteristics displayed by people in the environment. Processing commences at 400 whereupon, at step 405, an event occurs, such as the user turning on the mobile emotion identification system, a user request being received, an interaction being detected between the user and a human subject, etc. At step 410, the mobile emotion identification system monitors the environment where the user is currently located. The monitoring is performed by the receivers included in the mobile emotion identification system, such as video cameras, microphones, etc. The real-time inputs (e.g., visual inputs, audio inputs, etc.) captured by the mobile emotion identification system's receivers are stored in data stores, such as visual images data store 420 and audio data store 425.

At step 430, the mobile emotion identification system's processors identify the source of the real-time inputs being received. In other words, at step 430 the mobile emotion identification system identifies the human subject with whom the user is interacting. At step 440, characteristics regarding the first emotion are selected from visual emotion characteristics data store 360 and audible emotion characteristics data store 370. For example, first emotion being analyzed is “anger,” then facial and body language characteristics that exemplify “anger” are retrieved from visual emotion characteristics data store 360. Likewise, vocal tone characteristics that exemplify “anger” are retrieved from audible emotion characteristics data store 370. At step 450, the received real-time inputs that were received and captured from the human subject (visual images and audio) are compared with the characteristic data (visual and audible) exemplifying the selected emotion. A decision is made as to whether the real-time inputs that were received from the human subject match the characteristic data (visual and audible) exemplifying the selected emotion (decision 460). If the inputs do not match characteristic data for the selected emotion, then decision 460 branches to the “no” branch, which loops back to select characteristics from the next emotion from data stores 360 and 370. This looping continues until the real-time inputs that were received from the human subject match the characteristic data (visual and audible) exemplifying the selected emotion.

When the inputs match characteristic data for the selected emotion, then decision 460 branches to the “yes” branch to provide feedback to the user. Note, in one embodiment real-time inputs (visual images, audio, etc.) continue to be received while the system is comparing the real-time inputs to the various emotions. In this manner, additional data that may be useful in identifying the emotion being displayed by the human subject can continue to be captured and evaluated. In addition, if the human subject changes emotion (e.g., starts the interaction happy to see the user but then becomes angry in response to something said by the user, etc.), this change of emotion can be identified and feedback can be provided to the user so that, in this example, the user would receive feedback that the human subject is no longer happy and has become angry helping the user decide a more appropriate course or to apologize if necessary.

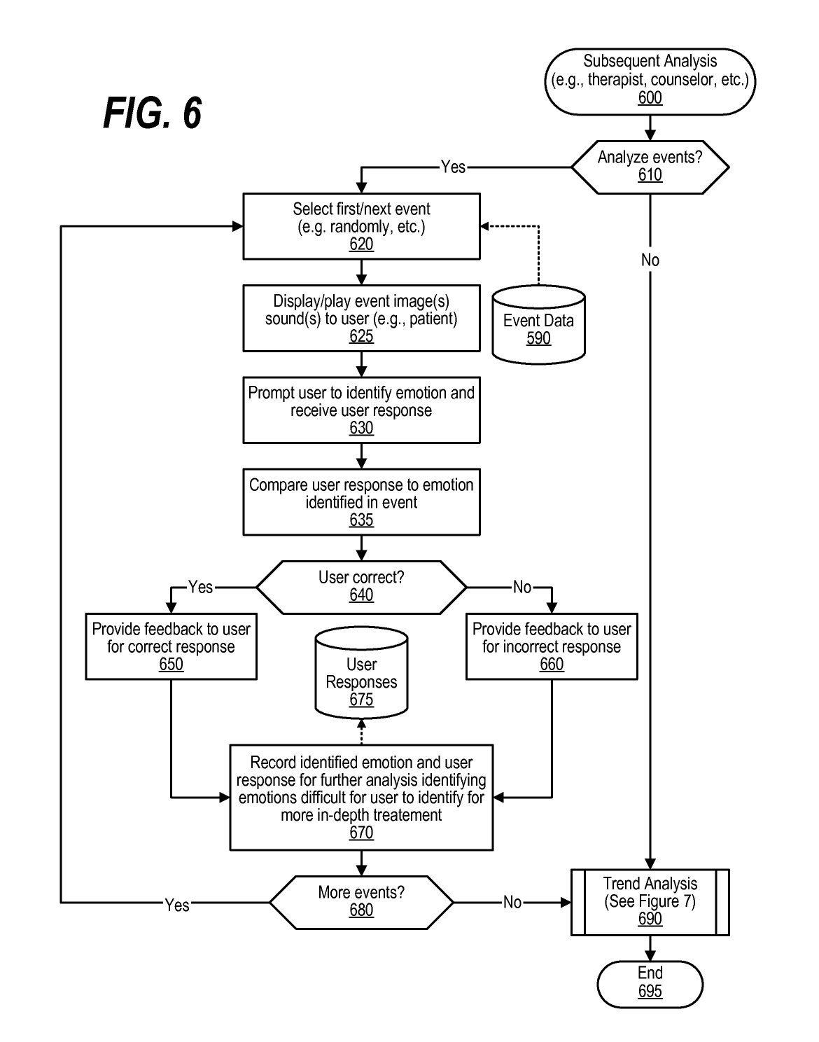

Predefined process 470 provides feedback to the user as to the identified emotion that is being displayed by the human subject (see FIG. 6 and corresponding text for processing details). A decision is made as to whether the user has ended the interaction (e.g., conversation, etc.) with the human subject (decision 480). If the interaction has not yet ended, then decision 480 branches to the “no” branch, which loops back to continue monitoring the environment, continue capturing the real-time inputs, and to continue identifying emotions that are displayed by the human subject. This looping continues until the mobile emotion identification system detects that the interaction between the user and the human subject has ended, at which point the mobile emotion identification system waits for the next event to occur at step 490. When the next event occurs, processing loops back to step 405 to commence the routine again (e.g., with another human subject, etc.).

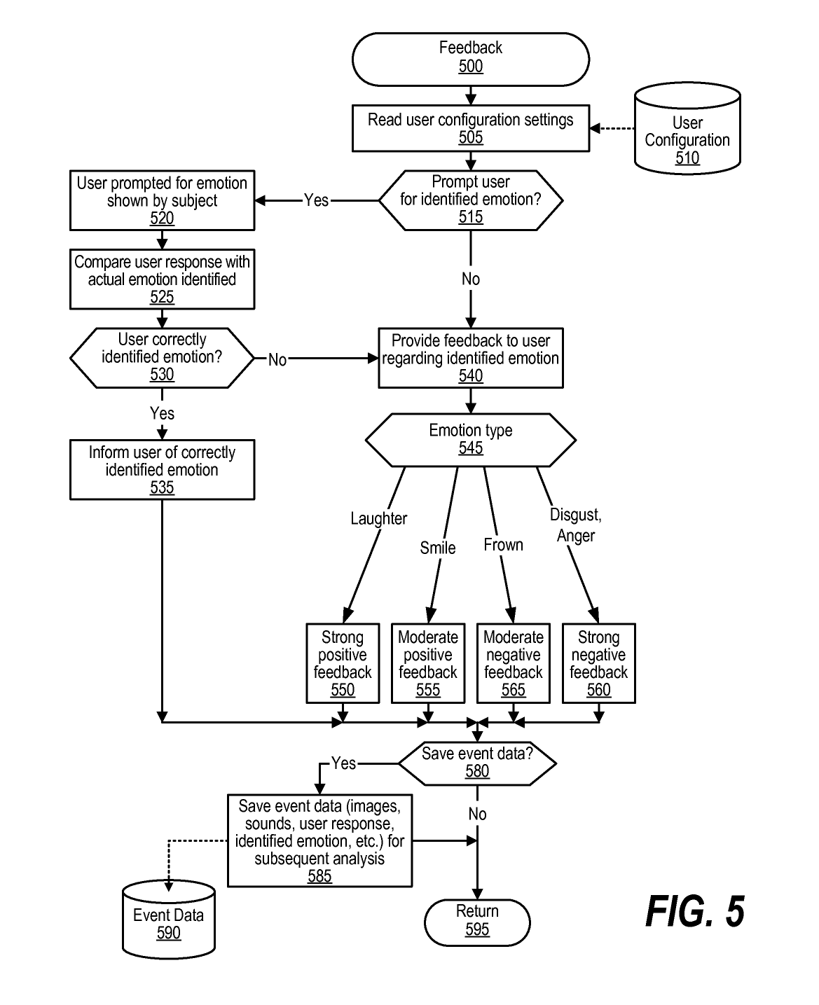

FIG. 5 is a flowchart showing steps performed by a process that provides feedback to a user of the mobile emotion identification system. This routine is called at predefined process 470 shown in FIG. 4. Processing in FIG. 5 commences at 500 whereupon, at step 505, user configuration settings are read from user configuration data store 510. In one embodiment, the user can configure the mobile emotion identification system to provide different types of feedback based on the user's preferences. In addition, in one embodiment the user can be prompted as to what emotion is being displayed by the human subject with the user then receiving almost instantaneous feedback as to whether the user correctly identified the emotion being displayed. Whether the user is being prompted to provide an emotion identification can also be included in the configuration settings.

A decision is made as to whether the user is being prompted to identify the emotion being displayed by the human subject (decision 515). If the user is being prompted to identify the emotion being displayed, then decision 515 branches to the “yes” branch whereupon, at step 520, the user is prompted to input the emotion that the user thinks is being displayed by the human subject. The prompt can be in the form of a sensory feedback (e.g., auditory “beep,” flash of both red and greed LEDs, etc.). In addition, at step 520, the user provides a response indicating the emotion that the user thinks is being displayed by the human subject, such as by using a small handheld controller or input device. At step 525, the response provided by the user is compared to the emotion identified by the mobile emotion identification system. A decision is made as to whether the user correctly identified the emotion that is being displayed by the human subject (decision 530). If the user correctly identified the emotion being displayed by the human subject, then decision 530 branches to the “yes” branch whereupon, at step 535, feedback is provided to the user indicating that the user's response was correct (e.g., vibrating the handheld unit used by the user to enter the response with a series of pulses, etc.). On the other hand, if the user did not correctly identify the emotion being displayed by the human subject, then decision 530 branches to the “no” branch for further processing.

If either the user is not being prompted for a response identifying the emotion of the human subject (decision 515 branching to the “no” branch) or if the user's response as to the emotion being exhibited by the human subject was incorrect (decision 530 branching to the “no” branch), then, at step 540, feedback is provided to the user based on the identified emotion. In addition, feedback may also be provided based on the intensity of the emotion that is identified. FIG. 5 provides several examples of positive and negative emotions that can be identified, however many more emotions can be identified and conveyed to the user. If the human subject exhibits a strong positive emotion, such as laughing, then decision 545 branches control to process 550 which provides strong positive feedback with the feedback based on the type of feedback mechanism being employed, such as those previously described in relation to FIG. 3, above (e.g., very rapid light vibrations, very cool temperature, quickly flashing green or white LEDs, high pitched tone, etc.). Likewise, if the human subject exhibits a moderate positive emotion, such as smiling, then decision 545 branches control to process 555 which provides moderate positive feedback with the feedback again being based on the type of feedback mechanism being employed, such as those previously described in relation to FIG. 3, above (e.g., moderately rapid light vibrations, moderately cool temperature, moderately flashing green or white LEDs, moderately high pitched tone, etc.).

If the human subject exhibits a strong negative emotion, such as anger or disgust, then decision 545 branches control to process 560 which provides strong negative feedback with the feedback based on the type of feedback mechanism being employed, such as those previously described in relation to FIG. 3, above (e.g., very rapid heavy vibrations, very hot temperature, quickly flashing red LED, low pitched tone, etc.). Likewise, if the human subject exhibits a moderate negative emotion, such as frowning, then decision 545 branches control to process 565 which provides moderate negative feedback with the feedback again being based on the type of feedback mechanism being employed, such as those previously described in relation to FIG. 3, above (e.g., moderately rapid heavy vibrations, moderately warm temperature, moderately flashing red LED, moderately low pitched tone, etc.).

A decision is made as to whether the mobile emotion identification system is saving the event data for future analysis purposes (decision 580). If the event data is being saved, then decision 580 branches to the “yes” branch whereupon, at step 585, the event data corresponding to the emotion exhibited by the human subject (e.g., images, sounds, etc.) are recorded as well as any user response (received at step 520). The event data and user response data are stored in event data store 590 for future analysis. On the other hand, if event data is not being saved, then decision 580 branches to the “no” branch bypassing step 585. Processing thereafter returns to the calling routine at 595.

FIG. 6 is a flowchart showing steps performed during subsequent analysis of the data gathered by the mobile emotion identification system. Processing commences at 600 whereupon a decision is made as to whether the person performing the analysis (e.g., a therapist, counselor, parent, etc.) wishes to analyze events captured by the mobile emotion identification system or wishes to perform trend analysis on a history of events (decision 610). If events captured by the user's mobile emotion identification system are being analyzed, then decision 610 branches to the “yes” branch for event analysis.

At step 620, a first interaction event is retrieved from event data store 590 recorded at the user's mobile emotion identification system. The event data includes the audio and/or video data captured by the mobile emotion identification system and used to identify the emotion exhibited by the human subject. At step 625, the previously captured event is replayed to the user (e.g., replay of the audio/video captured during the encounter with the human subject, etc.). At step 630, the user is prompted to provide a response as to what emotion the user now believes that the human subject was exhibiting. Through use of the mobile emotion identification system, users may become better at identifying emotions displayed by others. At step 635, the emotion identified by the mobile emotion identification system is compared with the user's response. A decision is made as to whether the user's response correctly identified the emotion being displayed by the human subject (decision 640). If the user correctly identified the emotion being displayed by the human subject, then decision 640 branches to the “yes” branch whereupon, at step 650, feedback is provided to the user regarding the correct response (e.g., how did the user recognize the emotion?, was identification of this emotion difficult?, etc.). Likewise, if the user's response was incorrect, then decision 640 branches to the “no” branch whereupon, at step 660, feedback is also provided to the user in order to help the user better understand how to identify the emotion that was identified as being displayed by the human subject (e.g., fear vs. anger, etc.).

At step 670, the identified emotion and the user's response to the displayed event are recorded in user response data store 675. In one embodiment, the recorded emotion and response data are used during further analysis and therapy to assist the user in identifying emotions that are more difficult for the user to identify and to perform historical trend analyses to ascertain whether the user's ability to identify emotions being displayed by human subjects is improving.

A decision is made as to whether there are more events in even data store 590 that the therapist wishes to review with the user (decision 680). If there are more events to process, then decision 680 branches to the “yes” branch which loops back to select and process then next set of event data as described above. This looping continues until there is either no more data to analyze or the therapist or user wishes to end the session, at which point decision 680 branches to the “no” branch.

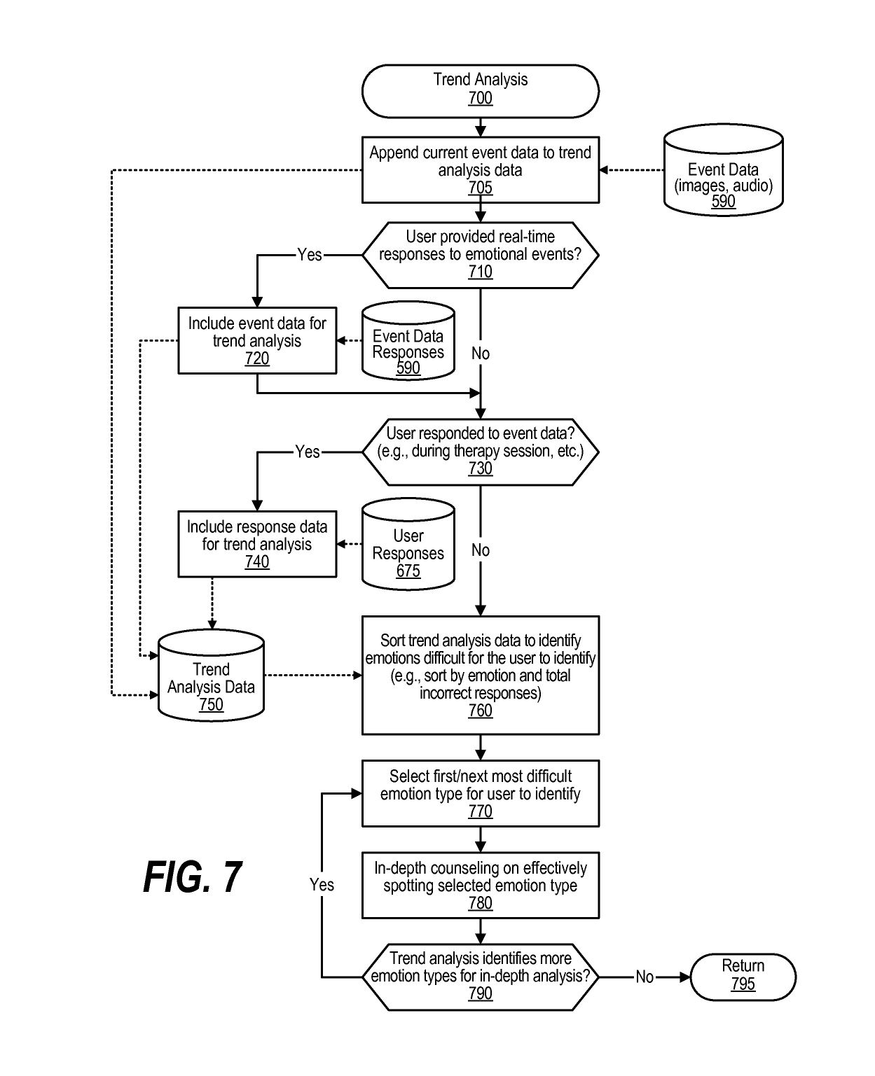

Returning to decision 610, if the event data captured by the mobile emotion identification system are not being analyzed, then decision 610 branches to the “no” branch bypassing steps 620 through 680. Predefined process 690 performs a trend analysis using historical user data gathered for this user (see FIG. 7 and corresponding text for processing details). Analysis related processing of user data thereafter ends at 695.

FIG. 7 is a flowchart showing steps performed during the subsequent analysis that focus on trend analysis for the user of the mobile emotion identification system. Processing commences at 700 whereupon, at step 705, the process appends the current event data (images, audio, etc.) to historical trend analysis data store 750. In this manner, historical trend analysis data store 750 continues to grow as the user continues to use the mobile emotion identification system.

A decision is made as to whether the user (e.g., patent, student, child, etc.) provided real-time responses regarding what emotions the user thought were being displayed by the human subject (decision 710). If the user provided real-time responses regarding what emotions the user thought were being displayed by the human subject, then decision 710 branches to the “yes” branch whereupon, at step 720, the event data that includes the human responses are included for trend analysis. At step 720, response data is retrieved from event data store 590 and written to trend analysis data store 750. On the other hand, if the user did not provide real-time responses regarding what emotions the user thought were being displayed by the human subject, then decision 710 branches to the “no” branch bypassing step 720.

A decision is made as to whether the user engaged in therapy sessions (e.g., such as the session depicted in FIG. 6, etc.) where the user responded to recorded event data (decision 730). If the user engaged in such therapy sessions, then decision 730 branches to the “yes” branch whereupon, at step 740, the response data gathered during the therapy sessions and stored in user response data store 675 are retrieved and written to trend analysis data store 750. On the other hand, if no such therapy sessions were conducted, then decision 730 branches to the “no” branch bypassing step 740.

At step 760, trend analysis data store 750 is sorted in order to better identify the emotions that have proven difficult over time for the user to correctly identify. In one embodiment, trend analysis data store 750 is sorted by the emotion exhibited by the human subject and the total number (or percentage) of incorrect responses received by the user for each of the emotions.

At step 770, the process selects the first emotion, which is the emotion type that is most difficult for the user to identify. At step 780, the therapist provides in-depth counseling to the user to provide tools, using the real-time inputs captured by the user's mobile emotion identification system, that better help the user in identifying the selected emotion type (e.g., identifying “fear” versus “anger”, etc.). A decision is made as to whether the trend analysis has identified additional emotion types with which the user has difficulty identifying (decision 790). If there are more emotion types with which the user has difficulty identifying, then decision 790 branches to the “yes” branch which loops back to select the next-most-difficult emotion type for the user to identify and counseling is conducted based on this newly selected emotion type. Decision 790 continues to loop back to process other emotion types until there are no more emotion types that need to be discussed with this user, at which point decision 790 branches to the “no” branch and processing returns to the calling routine (see FIG. 6) at 795.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of characterizing emotional cues, the method, implemented by an information handling system, comprising:
receiving, from a human subject, a set of real-time inputs at one or more receivers included in the information handling system, wherein the human subject is interacting with a user of the information handling system;
comparing the received set of real-time inputs to one or more predefined sets of emotional characteristics;
identifying an emotion being displayed by the human subject in response to the comparisons; and
providing feedback to the user of the information handling system regarding the identified emotion.

2. The method of claim 1 further comprising:
identifying an intensity of the emotion that is being displayed in response to the comparisons; and
providing additional feedback to the user regarding the identified intensity.

3. The method of claim 1 wherein the set of real-time inputs are visual inputs, the method further comprising:
receiving the visual inputs at a camera accessible by the information handling system, wherein the camera is directed at the human subject, and wherein the information handling system is a portable system that is transported by the user.

4. The method of claim 1 wherein the set of real-time inputs are audio inputs, the method further comprising:
receiving the audio inputs at a microphone accessible by the information handling system, wherein the microphone receives one or more vocal cues from the human subject, and wherein the information handling system is a portable system that is transported by the user.

5. The method of claim 1 wherein the feedback is provided to the user using a thermal output that provides a tactile sensation to the user, the method further comprising:
indicating the identified emotion as a cool sensation using the thermal output in response to a positive emotion being identified; and
indicating the identified emotion as a warm sensation using the thermal output in response to a negative emotion being identified.

6. The method of claim 5 further comprising:
identifying an intensity of the emotion that is being displayed in response to the comparisons;
increasing the cool sensation in response to a stronger positive emotion being identified; and
increasing the warm sensation in response to a stronger negative emotion being identified.

7. The method of claim 1 wherein the feedback is provided to the user using a vibrating output that provides a tactile sensation to the user, the method further comprising:
indicating the identified emotion as a light vibrating sensation using the vibrating output in response to a positive emotion being identified; and
indicating the identified emotion as a heavy vibrating sensation using the vibrating output in response to a negative emotion being identified.

8. The method of claim 7 further comprising:
identifying an intensity of the emotion that is being displayed in response to the comparisons;
increasing the frequency of the light vibrating sensation in response to a stronger positive emotion being identified; and
increasing the frequency of the heavy vibrating sensation in response to a stronger negative emotion being identified.

9. The method of claim 1 wherein the feedback is provided to the user using a speaker output that provides an audible feedback to the user, the method further comprising:
indicating the identified emotion as set of tones based on the identified emotion.

10. The method of claim 9 further comprising:
identifying an intensity of the emotion that is being displayed in response to the comparisons;
increasing the intensity of the set of tone in response to a stronger emotion being identified.

11. The method of claim 1 wherein the feedback is provided to the user using a display device that provides a visible feedback to the user, the method further comprising:
displaying a positive visible cue on the display device in response to a positive emotion being identified; and
displaying a negative visible cue on the display device in response to a negative emotion being identified.

12. The method of claim 11 further comprising:
identifying an intensity of the emotion that is being displayed in response to the comparisons;
increasing the intensity of the positive visible cue in response to a stronger positive emotion being identified; and
increasing the intensity of the negative visible cue in response to a stronger negative emotion being identified.

13. The method of claim 1 further comprising:
receiving, from the user, a response corresponding to the human subject, wherein the response is an emotion identification by the user, and wherein the response is received before the feedback is provided to the user; and
storing the user's response and the received set of real-time inputs in a data store.

14. The method of claim 13 further comprising:
performing a subsequent analysis of the interaction between the user and the human subject, wherein the analysis further comprises:
retrieving the user's response and the set of real-time inputs from the data store;
displaying the user's response, the identified emotion, and the one or more predefined sets of emotional characteristics corresponding to the identified emotion to the user; and
providing the retrieved set of real-time inputs to the user.

15. The method of claim 1 further comprising:
receiving, from the user, a response corresponding to the human subject, wherein the response is an emotion identification by the user, and wherein the response is received before the feedback is provided to the user;
storing the user's response and the received set of real-time inputs in a data store, wherein a plurality of sets of real-time inputs and a plurality of user responses related to a plurality of interactions between the user and a plurality of human subjects are stored in the data store over a period of time;
generating a trend analysis based on a plurality of comparisons between the plurality of user responses and the identified emotions corresponding to the plurality of sets of real-time inputs; and
identifying, based on the trend analysis, one or more emotion types that are difficult for the user to identify.
